(19) United States
(12) Patent Application Publication
(10) Pub. No.: US 2008/0103212 A1
(43) Pub. Date: May 1, 2008

(54) Treatment of fruit in storage facility with solid derived diphenylamine anti scald agent

(76) Inventor: Sukas Wartanessian, Glendale, CA (US)

Correspondence Address: Steven D. Boyd;Arkema Inc., 26 Floor, 2000 Market Street, Philadelphia, PA, 19103, US

(21) Appl. No.: 11/588,678

(22) Filed: Oct. 27, 2006

(51) Int. Cl. A01N 33/02

(52) U.S. Cl. 514/658

(57) ABSTRACT

Techniques for melting and forming aerosols from solid diphenylamine are disclosed. Solid diphenylamine in block, flake or powder form is convenient to ship and to handle. Solid diphenylamine is melted by controlled techniques to form a substantially pure liquid stream of diphenylamine. The molten or liquid stream of diphenylamine is converted to an aerosol of diphenylamine either by a pressurized, hot air stream or by a combustion gas stream.

### FIELD OF THE INVENTION

The present invention relates to the treatment of fruit such as apples and pears in storage with a diphenylamine (DPA) anti scald agent. More particularly, the present invention relates to the treatment of fruit such as apples and pears in storage with an aerosol diphenylamine anti scald treatment formed from solid diphenylamine.

### BACKGROUND OF THE INVENTION

Produce production in North America is a multi-billion dollar industry. Consequently, improving and preserving the quality of fruits, vegetables and other types of produce in terms of their color, taste, flavor and storage-life are of paramount importance to growers, produce-processing companies and the food industry in general. Unfortunately, the time window where most fruits, vegetables and produce exhibit peak quality is relatively narrow, and after this time window, the quality of the produce tends to decrease rapidly.

Fruit such as apples and pears are frequently held in cold storage after harvest. Superficial scald (or scald) is a physiological disorder that affects certain varieties of apples during or after post-harvest storage, lowering their market value. Varieties affected include Red Delicious, McIntosh, Cortland, Granny Smith and others. Collectively, these varieties comprise over 60% of the apples produced in Canada and the United States. In addition to affecting apples, superficial scald may also affect certain varieties of pears. Hereinafter the description of this invention will refer to apples, although it is to be understood that the present invention has applicability to other fruits susceptible to scald such as pears.

Superficial scald is primarily characterized by damage to the surface of fruit. Often, scald manifests as patchy browning on the surface of the fruit. This symptom can progress to internal damage and contribute to other pathological disorders. Superficial scald development in apples and pears is a form of targeted senescence, where the hypodermal cell layers (3-4 cell layers beneath the cuticle) undergo damage and deterioration. At present, the cause of superficial scald is unknown, but specific plant metabolic pathways have been implicated in its development. Also, environmental conditions such as hot dry weather, nutrient availability, and lack of appropriate chilling conditions during ripening may contribute to the development of superficial scald.

One theory regarding the mechanism of scald development proposes that the component a-farnescene, present in the superficial cell layers of fruit undergoes oxidation through an as yet unknown mechanism and the oxidized products somehow cause tissue damage and browning. Supporting the contention that free radicals may be involved in the development of the disorder, application of antioxidants such as a-tocopherol to scald-sensitive fruits can negate the development of superficial scald.

Scald development may be inhibited by treating scald-susceptible apples with diphenylamine (DPA). Typically DPA is applied to fruit in a finely particulate state of subdivision in water suspension, such suspension being prepared by dispersing the finely milled chemical (wetable powder or formulation, hereinafter WP) in water in the substantial absence of any auxiliary solvent. Although the use of such dispersions of DPA in water for scald prevention provide good results, the handling of the finely milled DPA powder is problematic. One means of avoiding the handling of such powered DPA was to provide concentrated liquid solutions (emulsifiable concentrates or formulations, herein after EC) of DPA which are diluted in water prior to application.

U.S. Pat. No. 3,526,520 discloses emulsions and dispersions of DPA in water in which separation of the emulsion or dispersion is controlled by adjusting the specific gravity of the emulsion or dispersion to greater than 1.000. The EC or WP product is diluted into water prior to application to fruit via dipping or drenching.

The application of DPA in aqueous solutions generates large amounts of hazardous waste, which has to be disposed of in accordance with appropriate laws. Further, the reuse and recirculation of the liquid DAP emulsion leads to the accumulation of pathogens in the drencher system which increases the disease incidents and eventually higher decay rates in the stored apples.

### SUMMARY OF THE INVENTION

To avoid these problems and speed up the treatment and storage of harvested fruit, the present inventor developed a process to apply solid DPA to fruit via an aerosol application process.

The instant invention describes techniques, compositions and apparatus for the application of molten DPA in the form of an aerosol to treat a fruit in a storage facility. The molten DPA is derived by melting substantially pure, solid DPA. While DPA has conventionally been provided as a powder or a solution of DPA in a solvent, utilization of pure DPA in molten form has advantages. The present invention provides means and techniques for melting solid blocks of substantially pure DAP at elevated temperatures, for example, temperatures greater than 60° C. and preferably greater than about 70° C. up to about 100° C. The molten DPA is collected in a reservoir which is maintained at a temperature of at least 54° C., the melting point of technical grade (99.9%) DPA, and preferably at temperatures upwards of about 90° C. or more, more preferably 100-120° C. to maintain the molten DPA in a highly flowable state.

Hot, liquid DPA is collected in a sump to exit the DPA reservoir and passed through a sieve or strainer where it is introduced into the intake of a pump, especially a peristaltic pump. The pump then conveys the molten DPA through a heated, insulated conduit to an aerosol-forming device, which converts the DPA into an aerosol. The aerosol may be directed into the storage facility.

One type of device which may be utilized to convert the liquid, molten DPA into an aerosol involves an appropriate nozzle which ejects a stream of molten DPA which may be contacted externally of the nozzle with jets of hot, pressurized air. The air is generally at a pressure of above about 150 psig and a temperature above about 400° C. and at least a portion of it is ejected tangentially from the same nozzle. The compressed air is preferably at a temperature above about 400° C. and is particularly effective at 450° C. and above.

Another type of aerosol-forming device is one which combusts propane, butane or similar hydrocarbon gas or gasoline whereby the molten DPA is directed downstream of the burners such that the hot gases coming off the burner interact with the DPA droplets to vaporize the DPA to form a stable aerosol.

There are numerous advantages to utilizing solid DPA as the starting material for treatment of fruit storage sheds and the like. Solid DPA is very safe to handle and may be readily made with a purity of greater than 98%, chemically pure DPA. Thus, there are few impurities or toxic materials which may be introduced into a fruit storage facility from such solid DPA. Also, solid DPA is extremely safe to ship and to handle, in contrast to a solution of DPA in an appropriate solvent, especially flammable solvents.

The use of solid DPA as the starting material from which an aerosol is formed eliminates the introduction of solvents into a storage facility.

### DETAILED DESCRIPTION OF THE INVENTION

The instant invention involves the formation of an aerosol from molten, substantially pure DPA derived by melting a solid mass of DPA. The melting of the DPA solid material, usually in the form of a block, flakes or chips is accomplished by placing the DPA in a first hot zone of a melting device which is at a sufficiently high temperature that rapid melting of the DPA results. Solid chips or flakes of DPA could be readily melted by exposing the flakes, in a porous basket to temperatures well above the melting point of DPA. When molten DPA is used to form an aerosol, the application rate of DPA to fruit in a storage facility may be limited by the rate of melting of the DPA block material. Thus, rapid melting permits rapid formation of aerosol and rapid treatment of a storage facility.

A second hot zone is preferably maintained which receives the molten DPA, which had melted in the first zone. The second hot zone may be maintained at a lower temperature, for example, 75-80° C. compared to temperatures significantly in excess of 90° C., for example, about 100° C. in the first zone. The second zone is maintained at a temperature, which provides the DPA with substantial heat content as well as optimum fluidity. Heat content of the liquid DPA is important to preclude freezing of the liquid at any point between the second hot zone and the aerosol-forming device.

The second hot zone is preferably located at a lower level in the same tank as the first hot zone so that molten DPA drains by gravity directly from the first hot zone into the second. The DPA from the second hot zone is pumped through an insulated and preferably heated line to an aerosol-forming device, which forms an aerosol of the DPA. The aerosol DPA is then distributed throughout a storage facility via the normal air circulation system of the storage facility. The aerosol-forming device may be one of several types of devices as are known in trade.

DPA is preferably provided in a solid form in containers such plastic bags and placed in metal or cardboard containers or as bricks packed in plastic bags and placed in cardboard boxes. A block or brick of DPA may be placed in the first hot zone of the melting device. As the DPA becomes warm, the block of DPA will remain in the hot zone until it is totally melted.

The reservoir into which the DPA melts preferably has a volume, which is greater, than a single block of DPA. Thus, a second block of DPA may be placed in the first hot zone and started to melt before all of the DPA has been pumped from the second hot zone or reservoir.

In one embodiment, a tank is provide which rests on a heating element. The tank preferably has a lid to help maintain appropriate temperatures in the tank and to minimize the escape of the vapors of DPA which may emanate during the melting of the DPA. A plurality of heating elements may be placed in the form of a grid or grill so that the block of DPA may rest thereupon. The elements are preferably thermostatically controlled by a thermocouple and temperature controller so as to maintain the temperature of the heating elements generally between about 80-100° C. and preferably at about 90° C. DPA melts at about 55° C. Maintaining a temperature approximately twice the melting temperature causes rapid melting of the DPA even though the DPA itself does not achieve a temperature much greater than 100° C. in the first hot zone.

The DPA melts and drops into the bottom of the tank, wherein the temperature is maintained at least 55° C. and preferably above 75° C. and generally at temperatures of about 90° C. or higher, more preferably 100-120° C. to maintain optimum fluidity and heat content for the DPA. A heating element may be secured to the bottom of the tank with an appropriate thermocouple located in the tank or on the tank bottom adjacent the heating element and interacting with a temperature controller to maintain the temperature of the liquid DPA at an appropriate level, or the container can be placed on a hot plate with a temperature controller to maintain the temperature of the liquid DPA at an appropriate level.

Molten DPA in a highly flowable state is withdrawn from the tank through a sump and optionally a sieve into the intake of a pump. Preferably, a peristaltic pump is used for this purpose although other types of pumps may be used. The conduit leading from the tank to the pump is of a plastic tubing, such as silicone, polyethylene, polypropylene, Tygon® (vinyl tubing) or the like, having heat characteristics suitable for handling the temperatures involved with the molten DPA. The pump discharge is conveyed through conduit, which is insulated and preferably electrically heated, to an aerosol-forming device. The pump and tank are preferably located in an insulated enclosure. The insulated enclosure has openings to make the top of the tank and the pump accessible. These openings are fitted with insulated doors. The heated tank maintains the interior of the insulated enclosure at a sufficiently high temperature that the pump and lines within the enclosure, such as conduit, do not need to be insulated. The temperature of the space in the insulated enclosure typically remains well above 90° C. because of the elevated temperature of the hot tank and the insulated enclosure.

The molten DPA passes through the insulated, heated conduit where it is preferably maintained at a temperature of about 100° C. to enter an aerosol-forming device. The pipe of the aerosol-forming device is preferably placed in an opening in the door or wall of a fruit storage facility downstream of the air circulation fan. The air circulation fans are preferably shut down during the fumigation and will reactivated about 1-2 hours after the application of the DPA. An aerosol of substantially pure DPA is formed with air as the only added ingredient to cause an aerosol to occur. Thus, no contaminants of any type are carried into the storage facility. It has been found that when a system of the type described is been used to treat storage facilities, there is very little solid residue of material found on the storage floor and the residue of DPA on the fruit is excellent.

The molten DPA must be maintained at an elevated temperature, for example, above 60° C. and preferably near 90° C., more preferably 100-120° C. during its transport from the melting tank to the aerosol-forming device. If the DPA contacts any cold junctions, it will immediately freeze and plug up the system. Thus, it is important that the complete conduit between the DPA pump and the aerosol-forming device be insulated and electrically heated. If two or more electrically heated conduits must be joined, these junctions must be well insulated and preferably located inside insulated boxes or the like to avoid freezing of the DPA. The DPA melting portion of the system is located externally to a storage facility.

As an alternative means of application of the molten DPA, it can be fed into a thermal/combustion fogger of know design. Typically, combustion-type foggers are run at about 400 to 500° C. in order to form an effective, stable spray of a solvent-based solution of DPA. In using molten DPA, it is believed that a combustion fogger can be operated very well at lower temperatures. It is believed that fogging could be conducted at temperatures as low as 250° C. This is a significant advantage in as much as significantly less heat is put into the storage shed.

There are advantages to each of the two systems described above. With an electrically heated fogger for the molten aerosol system, only air and DPA are directed into the storage facility. With the thermal/combustion fogger system, existing combustion fogging devices can be utilized with pure, molten DPA. Combustion foggers utilizing molten, substantially pure DPA operate more efficiently and introduce less harmful materials to the storage sheds than similar fogging units using solvent-based DPA.

Generally, it is desired that hot, compressed air be fed to the aerosol-forming nozzle before molten DPA is pumped to the nozzle. The hot air warms the nozzle and ensures that liquid DPA in the nozzle does not freeze. The aerosol-forming nozzle is preferably located closely adjacent the heat exchanger housing so that any uninsulated conduit carrying DPA to the nozzle is very short. Preferably, the DPA conduit line connected to the nozzle is metal so that heat from the hot nozzle is conducted along the DPA line toward the heat exchanger enclosure to further minimize the possibility that DPA will freeze in the exposed line.

### EXAMPLES

### Example 1

DPA was applied to Granny Smith and Red Delicious apples at a research facility. Solid, technical grade (99.5%) DPA was melted and applied to the apples in a storage facility as an aerosol using a commercial thermal fogger equipment, provided by Custom Chemical of Warden Wash., as described above. The apples were loaded into 20 bins, of 900 pounds each, of each variety and stacked in a three by three arrangement. The bins were stacked: five high in all of the back rows, in a 5-4-5 high arrangement in the center row and in a 4-3-4 arrangement in the front row. DPA was applied at a rate of 15 grams per ton. This represents a 50% excess to account for any loss in void spaces. The thermal fogging equipment was placed in the hallway of the storage facility with two 10 foot lengths of flex pipe attached to a porthole in the door of the sealed storage room. Fumigating started and reached optimum saturation in 15 minutes. The porthole was then sealed and the room was left alone for 16 hours. Application of the aerosol DPA began with the storage facility fans off. The fans were turned on after 10 minutes of aerosol DPA application and run at ambient temperatures for 12-16 hours. The morning after application the room was unsealed the apples, bins, storage walls and fan blades were checked for anomalies such as DAP sublimation as crystals and possible phytotoxicity on the fruit. None was found.

After the initial inspection the bins were arranged outside of the building so samples could be taken. Each bin was marked as to its location in the room and samples were marked with those same ID codes. Samples were taken from the top of each bin and also by digging into the center of the bin. Each bin was effectively sampled two times. These samples were tested for DPA residual by gas chromatography. The bins were than transferred to a cold air storage facility and observed for five months. Periodically samples were collected for DPA residue, scald and decay analysis as describe below.

After 6 weeks additional samples were taken and tested for DPA residual by gas chromatography. These samples were taken like the first set, eight apples from the top of the bin and then digging into the center for eight apples. After two months in common storage four bins were set out for evaluation, two Granny Smith and two Red Delicious. No Scald was apparent in any bin, with some shrivel from damaged fruit. No decay was apparent.

The next samples were taken one month later. The appearance of decay was becoming obvious in the Red Delicious bins but not in the Granny Smith bins. Scald was not showing in either variety.

One month later samples were taken in the same fashion as before, top and middle of the bins. Because a fungicide was not used, penicillium rot was showing in about 8% of the Red Delicious samples. The Granny Smith samples were starting to show some decay, roughly ½ percent. Scald was not apparent in either variety.

The next to last sample was taken about 6 weeks later. Scald was not a problem. The Red Delicious apples are overripe and approximately 8% were exhibiting signs of decay. The Granny Smith apples looked good with only about one percent showing signs of decay with no scald found in any bin.

Approximately two weeks later, the final assessment showed no changes from the prior evaluation. There was no additional scald in the fruit, which showed that the treatment worked effectively to inhibit scald. The positive impact of the treatment was especially evident in the Granny Smith apples which are more susceptible to scald. The decay incidences were unchanged. As stated in the earlier, there was generally a slightly higher decay rate in Red Delicious compared to prior art drench type applications, which typically use one or a combination of two fungicides. The decay in this test was attributed to the lack of fungicide use in this trial.

Table 1 summarizes the DAP residue measurements for the sampled apples removed 16 hours after application. Table 2 summarizes DPA residue on apples sampled four months after DPA application. The sample IDs in the tables identify which bin the apples came from eg.: R-2-3-T: sample taken from the top of the bin #3 in second right side column. R-2-3-M: Sample taken from the middle of the bin #3 in second right side column.

TABLE 1
DPA RESIDUE (PPM)

| Sample | | | | | |
|---|---|---|---|---|---|
| ID# | RESIDUE | VARIETY | Sample ID# | RESIDUE | VARIETY |
| L1-1-T | 2.2 | Red DEL | M2-1-T | 1.4 | Granny S. |
| L2-1-T | 2.2 | Red DEL | M2-2-M | 0.7 | Granny S. |
| L3-1-T | 1.1 | Granny S. | M2-2-T | 0.8 | Granny S. |
| L3-3-T | 0.7 | Granny S. | M2-3-M | 1.3 | Granny S. |
| L3-5-T | 0.7 | Granny S. | M2-3-T | 1.5 | Granny S. |
| M1-1-M | 1.1 | Red DEL | M2-4-T | 1.3 | Granny S. |
| M1-1-T | 1.1 | Red DEL | M3-1-T | 2.1 | Red DEL |
| M1-2-T | 0.3 | Red DEL | M3-2-T | 5.2 | Red DEL |
| M1-3-M | 1.5 | Red DEL | M3-3-T | 2.8 | Red DEL |
| M1-3-T | 0.7 | Red DEL | M3-4-M | 1.3 | Red DEL |
| M3-4-T | 1.1 | Red DEL | R2-1-T | 2.0 | Red DEL |
| M3-5-T | 1.0 | Red DEL | R2-3-T | 1.6 | Red DEL |
| R1-1-T | 1.3 | Granny S. | R2-5-T | 1.6 | Red DEL |
| R3-1-T | 2.3 | Granny S. | | | |
| R3-3-T | 1.2 | Red DEL | | | |
| R3-5-T | 1.6 | Granny S. | | | |

TABLE 2
DPA RESIDUE (PPM) VARIATION AT FOUR MONTHS

| | 16 | | 14 | 18 | 20 | |
|---|---|---|---|---|---|---|
| Bin ID | Hours | 8.5 Weeks | Weeks | Weeks | weeks | Variety |
| M2-2-T | 0.8 | 2.7 | 1.1 | 0.5 | 0.5 | Granny |
| | | | | | | Smith |
| M2-2-M | 0.7 | 2.6 | 0.9 | 0.6 | 0.5 | Granny |
| | | | | | | Smith |
| M2-3-T | 1.5 | 1.9 | 0.8 | 0.6 | 0.6 | Granny |
| | | | | | | Smith |
| M2-3-M | 1.3 | 2.8 | 1.0 | 0.7 | 0.8 | Granny |
| | | | | | | Smith |
| M3-4-M | 1.1 | 4.4 | 2.5 | 1.3 | | Red |
| | | | | | | Delicious |
| M3-5-M | 1.3 | 4.2 | 3.1 | 1.9 | | Red |
| | | | | | | Delicious |
| M3-5-T | 1.0 | 3.4 | 2.3 | 1.2 | | Red |
| | | | | | | Delicious |
| M3-5-M | 1.2 | 3.6 | 2.8 | 1.6 | | Red |
| | | | | | | Delicious |

The data in Tables 1 and 2 show the relatively consistent application of DPA via the process of the present invention and long term residual effect. The observations show that effective scald protection was provided by the process of the present invention.

### Example 2

A combination of DPA and Imazalil (a fungicide, hereinafter IMZ) was applied to Granny Smith and Fuji apples. Solid, technical grade (99.0%) DPA and technical grade IMZ (99.0%) was melted and applied to apples in a storage facility as an aerosol using commercial thermal fogger equipment as described above. The apples were loaded into 50 bins, 400 kilograms each, of each variety and stacked in a five by five arrangement in a sealed storage room. The bins in the back row were stacked six high with each successive row, moving forward, being one bin lower with the front two rows each 2 bins high. The DPA/IMZ combination was applied at a rate of 20 grams per ton DPA and 10 grams per ton IMZ.

800 grams of technical grade DPA and 400 grams of technical grade Imazalil were loaded into the chemical port of the fogger. The materials were heated to 100° C. to melt the crystalline materials. The melting materials were stirred to homogenize the mixture. The homogenized mixture was maintained at a temperature between 100-120° C. Fumigation was started with the storage room fans and humidifiers off. The fumigation entailed pumping 2.5-3.0 ml/s of the DPA/IMZ mix through the fumigator hot zone of approximately 450° C. The fumigation took 6-8 minutes. The storage room fans were turned on 10 minutes after the application began and run at ambient temperature for 12-16 hours. Thereafter, the fruit was assessed for physical damage and for treatment chemical residue. Fruit samples for assessment were removed form the top, middle and bottom of bins in all rows. The treatment room was also inspected for chemical distribution by inspecting the storage room floor, walls, ceiling, bins, fan blades. The bins were then transferred to RA (Regular Cold storage) or CA storage (Controlled Atmosphere storage, storage at lower oxygen and higher carbon dioxide concentration than normal atmosphere).

Samples stored on CA will be evaluated for treatment residue after opening of the CA storage. This procedure was run twice, Test #1 and Test #2. Table 3 shows the initial residue measurements of Test #1 for both DPA and IMZ on samples both varieties of apples taken from the top and middle of selected bins prior to transfer to CA storage. Table 4 shows the initial DPA and IMZ residue on samples both varieties of apples taken from the top and middle of selected bins from Test # 2.

In Tables 3 and 4, the Bin ID A5#6 indicates the top (A) of column 1 (from let to right) row 6 (front to back). B2#6 indicates second from top (B) of column 2 (right to left) row 6 (front to back) and so on.

TABLE 3
Initial DPA/IMZ Residue for Test #1

| | Top | | Middle of | Middle of | |
|---|---|---|---|---|---|
| | Of Bin | | Bin | Bin | |
| | DPA | Top Of Bin | DPA | IMZ | |
| Bin ID | (PPM) | IMZ (PPM) | (PPM) | (PPM) | Variety |
| A5#6 | 1.7 | 2.2 | 1.2 | 1.2 | Fuji |
| D4#5 | 1.2 | 1.9 | 0.7 | 0.5 | Fuji |
| D5#4 | 0.7 | 0.7 | 0.9 | 0.7 | Fuji |
| E2#2 | 2.8 | 1.8 | 1.0 | 0.6 | Fuji |
| E4#3 | 0.7 | 0.7 | 0.4 | 0.1 | Fuji |
| E4#4 | 2.2 | 0.5 | 1.8 | 0.4 | Fuji |
| B1#5 | 2.6 | 2.3 | 1.0 | 0.5 | Granny Smith |
| D1#6 | 2.2 | 0.2 | 1.1 | 0.5 | Granny Smith |
| E2#2 | 0.7 | 0.5 | 0.3 | 0.3 | Granny Smith |
| F1#4 | 0.7 | 0.5 | 0.7 | 0.3 | Granny Smith |
| F2#6 | 0.8 | 0.7 | 0.7 | 0.4 | Granny Smith |
| F3#5 | 0.7 | 0.6 | 0.7 | 0.4 | Granny Smith |

TABLE 4
Initial DPA/IMZ Residue for Test #2

| | Top | | Middle of | Middle of | |
|---|---|---|---|---|---|
| | Of Bin | Top Of Bin | Bin | Bin | |
| | DPA | IMZ | DPA | IMZ | |
| Bin ID | (PPM) | (PPM) | (PPM) | (PPM) | Variety |
| B2#6 | 5.9 | 1.3 | 7.1 | 0.6 | Fuji |
| D3#6 | 5.9 | 2.5 | 4.4 | 0.6 | Fuji |
| D4#6 | 5.6 | 0.3 | 2.3 | 0.6 | Fuji |
| E2#4 | 4.7 | 0.2 | 2.5 | 0.6 | Fuji |
| E2#5 | 3.8 | 0.9 | 4.6 | 0.4 | Fuji |
| E4#2 | 6.4 | 0.5 | 3.8 | 1.0 | Granny Smith |
| E4#4 | 3.1 | 0.7 | 1.9 | 1.1 | Granny Smith |
| F2#3 | 5.0 | 0.5 | 2.7 | 0.8 | Granny Smith |
| F3#4 | 4.4 | 0.4 | 3.5 | 0.5 | Granny Smith |
| F5#5 | 6.0 | 0.5 | 5.4 | 0.8 | Granny Smith |

The data in Tables 3 and 4 show effective application of the DPA/IMZ combination to the apples. It is expected that scald control similar to that evidenced in Example 1 will be provided with improved decay control over Example 1 due to the use of the IMZ fungicide.

Although the invention is illustrated and described herein with reference to specific embodiments, it is not intended that the subjoined claims be limited to the details shown. Rather, it is expected that various modifications may be made in these details by those skilled in the art, which modifications may still be within the spirit and scope of the claimed subject matter and it is intended that these claims be construed accordingly.

What is claimed:

1. A method for treating a fruit in a storage enclosure with an aerosol of diphenylamine scald inhibitor comprising:
a) melting a solid diphenylamine scald inhibitor at a temperature greater than about 100° C. in a heated zone to form molten diphenylamine scald inhibitor;
b) collecting said molten diphenylamine scald inhibitor in a reservoir;
c) maintaining the temperature of the molten diphenylamine scald inhibitor in said reservoir at a temperature above about 90° C.;
d) conveying said molten diphenylamine scald inhibitor from said reservoir through a heated conduit to maintain the temperature of said molten diphenylamine scald inhibitor at a temperature greater than 55° C. to an aerosol-generating device, wherein said heated zone and said reservoir are located within an insulated enclosure and wherein said aerosol-generating device is located outside of said insulated enclosure;
e) forming an aerosol consisting essentially of said molten diphenylamine scald inhibitor in said aerosol-generating device; and
f) directing said aerosol of diphenylamine scald inhibitor into a fruit storage enclosure.

2. The method of claim 1 wherein said solid diphenylamine scald inhibitor contains at least 99% chemically pure diphenylamine.

3. The method of claim 1 wherein said solid diphenylamine is a pre-weighed blocks, crystals, powder or flakes of diphenylamine

4. The method of claim 1 wherein said heated zone is maintained at a temperature above about 60° C.

5. The method of claim 1 wherein said aerosol-generating device is a combustion or electrical fogger aerosol-generating device.

6. The method of claim 1 wherein a fungicide is mixed with said molten diphenylamine scald inhibitor prior to forming an aerosol.

7. A method for spraying an aerosol of molten diphenylamine scald inhibitor comprising:
a) melting solid diphenylamine at a temperature of at least about 54° C. to form liquid diphenylamine scald inhibitor;
b) transporting said liquid diphenylamine scald inhibitor through heated tubing at a positive pressure and a temperature of at least about 60° C. to a spray nozzle;
c) injecting air into said spray nozzle; and
d) directing said molten diphenylamine scald inhibitor through a central exit opening in said nozzle and circumferentially exiting said air from said nozzle around said ejected diphenylamine and directing at least a pair of compressed gas streams tangentially to contact said central air-diphenylamine scald inhibitor stream externally to said nozzle to form an aerosol containing said diphenylamine scald inhibitor.

8. The method of claim 7 wherein the compressed air flow rate to said nozzle is adjusted to the molten diphenylamine flow rate to obtain an aerosol.

9. The method of claim 7 wherein said solid diphenylamine scald inhibitor contains at least 99% chemically pure diphenylamine.

10. The method of claim 7 wherein a fungicide is mixed with said liquid diphenylamine scald inhibitor.
